(19) United States
(12) Patent Application Publication
(10) Pub. No.: US 2014/0346409 A1
(43) Pub. Date: Nov. 27, 2014

(54) CARBON FIBER FOR COMPOSITE MATERIALS HAVING IMPROVED CONDUCTIVITY

(71) Applicant: TOHO TENAX EUROPE GMBH, Wuppertal (DE)

(72) Inventors: Silke Witzel, Wuppertal (DE); Bernd Wohlmann, Dusseldorf (DE); Silke Stüsgen, Neuss (DE)

(21) Appl. No.: 14/359,058

(22) PCT Filed: Dec. 6, 2012
(86) PCT No.: PCT/EP2012/074649

§ 371 Date: May 16, 2014

(30) Foreign Application Priority Data
Dec. 7, 2011 (EP) 11192309.0

(51) Int. Cl. H01B 1/04; H01B 13/00; H01B 1/02

(52) U.S. Cl. CPC H01B 1/04; H01B 1/02; H01B 13/0026
USPC 252/506; 205/50; 205/159

(57) ABSTRACT

A carbon fiber with a conductive finish includes carbon fiber filaments including a metal coating, wherein the carbon fiber filaments have a finish on the metal coating based on at least one polymer binder and containing conductive nanoparticles. The concentration of the metal coating is 8 to 25 wt. % and the concentration of the carbon nanotubes is 0.1 to 1 wt. %, each relative to the weight of the carbon fiber provided with the metal coating and finish. A method for producing fibers of this type is set forth, as well as a fiber-reinforced composite material comprising carbon fibers including carbon fiber filaments, wherein the carbon fiber filaments are coated with a metal, and a polymer-based matrix, wherein the percent by volume of the fibers in the composite material is 30 to 70 vol. % and the composite material additionally contains conductive nanoparticles which are dispersed at least partially in the matrix.

This application is a U.S. national phase application of PCT/EP2012/074649 filed Dec. 6, 2012, and claims priority to EP 11192309.0 filed Dec. 7, 2011. The prior applications are each incorporated by reference herein in its entirety.

### BACKGROUND

The invention relates to carbon fibers with a conductive finish which lead to an improved conductivity in fiber-reinforced composite materials. In addition, it relates to fiber-reinforced composite materials having improved conductivity.

It is known to use carbon fibers which have been provided with a metal coating to improve the conductivity of fiber-reinforced composite materials. Fibers of this type and the production thereof are described for example in EP-A-0 149 763 A. Commercially available carbon fibers with a nickel coating lead to an improved conductivity in composite materials produced therewith. However, such composite materials based on nickel-coated carbon fibers have the disadvantage of a higher specific gravity, which is due to the nickel proportion required to achieve good conductivity and can be 30-40 wt. % relative to the fiber weight. In addition, the use of nickel-coated carbon fibers is also problematic because of health and safety risks.

In an alternative for improving the conductivity of composite materials based on carbon fibers, flat metal networks, such as copper in the form of grids or meshes, are applied to the composite materials and/or incorporated into the composite materials. Copper or aluminum are often used as materials. In comparison to composite materials based on nickel-coated carbon fibers, lower specific gravities can be realized thereby with good conductivity in the extension direction of the metal networks. However, the conductivity perpendicular to the extension of the metal networks, i.e., in the direction of the thickness of the composite materials, is insufficient. In addition, the drapability of such metal networks during the production of components with curved geometries is often not satisfactory.

It is likewise known to use carbon fibers which have a yarn finish containing carbon nanotubes (CNT) to improve the conductivity of composite materials. A method for producing duromeric polymer composite materials based on fibers which have a finish containing nanotubes is disclosed, e.g., in WO 2010/007163. US 2010/0260998 relates to formulations for finishes containing nanoparticles and to fibers which are provided with a finish in which the nanoparticles are dispersed.

US 2010/0104868 discloses hybrid fibers having a coating with a plurality of components, wherein this coating is produced by simultaneous deposition of nanoparticles and a metal via electrophoretic and/or galvanic processes. As a result of the simultaneous deposition, the nanoparticles are embedded into and surrounded by the metal, and both adhere to the fiber surface, so that a mixed structure is obtained. Carbon fibers onto whose surface a metal layer containing nanoparticles is applied are also disclosed in WO 2011/000394.

Although an improvement of the conductivity of fiber composite materials is achieved by means of the known measures, there is a need for further improvements in view of the conductivity of carbon-fiber-reinforced composite materials.

### SUMMARY

Therefore, it is an object of the present invention to provide reinforcing fibers which lead to an improved conductivity of the composite materials produced therewith. It is likewise an object of the present invention to provide composite materials with improved conductivity.

The object is achieved by a carbon fiber with a conductive finish, consisting of carbon fiber filaments which have a metal coating, characterized in that the carbon fiber filaments have a finish on the metal coating based on at least one polymer binder and containing conductive nanoparticles, and that the concentration of the metal coating is 8 to 25 wt. % and the concentration of the conductive nanoparticles is 0.1 to 1 wt. %, each relative to the weight of the carbon fiber provided with the metal coating and finish.

### BRIEF DESCRIPTION OF THE DRAWINGS

FIG. 1 illustrates a sample laminate test piece with three contact areas labeled.

FIGS. 2a and 2b illustrate measurement of the electrical resistance R with a multimeter having electrodes at the labeled measuring points.

### DETAILED DESCRIPTION

It has been shown that, by using carbon fibers coated with a conductive finish, consisting of carbon fiber filaments which have a metal coating, characterized in that the carbon fiber filaments have a finish on the metal coating based on at least one polymer binder and containing conductive nanoparticles, and that the concentration of the metal coating is 8 to 25 wt. % and the concentration of the conductive nanoparticles is 0.1 to 1 wt. %, each relative to the weight of the carbon fiber provided with the metal coating and finish, composite materials are obtained which have an improved conductivity and simultaneously acceptable specific gravity, which can be reduced by up to approximately 25% in comparison to the known composite materials based on nickel-coated carbon fibers. In addition, it was found that in particular the bulk conductivity, i.e., the conductivity in the direction of thickness of the composite materials, can be substantially increased in comparison to known composite materials in which, e.g., copper networks are incorporated to improve conductivity.

The carbon fiber with a conductive finish according to the invention can be based on conventional carbon fiber yarns, i.e., it can be a yarn made of short fiber filaments or a yarn made of continuous filaments. In the case that the yarn consists of continuous filaments, the number of filaments can lie preferably in the range from 3000 to 48000 and particularly preferably in the range from 6000 to 24000. Likewise, yarns having a linear density in the range from 200 to 32000 tex are preferred, and yarns are particularly preferred that have a linear density in the range from 400 to 16000 tex. Regarding the mechanical characteristics of the carbon fiber, i.e., regarding the strength and modulus thereof, conventional carbon fibers can be used. The carbon fiber can likewise be based on yarns obtained from pitch, polyacrylonitrile, lignin, or viscose precursors.

The metal forming the metal coating can be nickel, cobalt, copper, platinum, tin, cadmium, zinc, silver, gold, etc. or alloys of at least two of these metals. Different metals can also be applied in different layers to the carbon fiber filaments. Preferably, the metal forming the metal coating is copper.

For good conductivity of the carbon fibers according to the invention, it is important that the metal coating covers the filament surface uniformly and continuously. Conventional thicknesses of the metal coating lie in the range from 0.01 to 0.5 μm. Within the context of the present invention, a concentration of the metal coating of 10 to 25 wt. % is preferred. A concentration of the metal coating lying in the range from 10 to 20 wt. % relative to the weight of the carbon fiber provided with the metal coating and finish is particularly preferred. At metal concentrations of this type, a good handling ability of the carbon fibers is guaranteed on the one hand, and composite materials with high conductivity and low specific gravity can be produced on the other.

The conductive nanoparticles can be for example carbon nanotubes (CNT), carbon nanorods, carbon nanorings, carbon nanospheres, fullerenes, carbon nanobuds, or graphenes, or nanoparticles made of transition metals, which preferably have diameters in the range from 0.4 to 100 nm. The conductive nanoparticles contained in the finish are preferably carbon nanotubes, which can be single- or multi-walled. The conductive nanoparticles decisively contribute to the improvement of the conductivity of the composite materials. In particular, they lead to an improvement of the bulk conductivity of the composite materials produced using the carbon fiber with a conductive finish according to the invention. It has been shown that, during the production of composite materials using the carbon fibers according to the invention, the conductive nanoparticles move at least partially out of the finish into the matrix material, disperse therein, and thus lead to an improvement of the conductivity. In a preferred embodiment, the concentration of the conductive nanoparticles is 0.1 to 0.5 wt. % relative to the weight of the carbon fiber provided with the metal coating and finish.

The finish on the metal-coated carbon fibers is based on at least one polymer binder in which the conductive nanoparticles are embedded. Regarding the at least one polymer binder, the components conventionally used for finishes for carbon fibers, such as resins which react to duromer polymers, or thermoplastic polymers, can be used. The finish preferably comprises at least one epoxy resin and/or at least one polyurethane resin. In view of the type and properties of the matrix material, which is processed together with the carbon fibers according to the invention into composite materials, the finish can contain additional components such as additional resins which react to duromer polymers, or thermoplastic components such as polyamides, polyhydroxyethers, or thermoplastic polyurethane resins, which can also be present in the form of fine particles.

The invention also relates to a method for producing the carbon fibers with a conductive finish according to the invention for composite materials with improved conductivity, wherein the method comprises the following steps:
a) Provision of a carbon fiber consisting of carbon fiber filaments,
b) Performing a coating process to deposit a metal in the form of a metal coating on the filaments,
c) Application of a finish to the filaments provided with the metal coating, wherein the finish contains conductive nanoparticles.

The method according to the invention can be performed as a two-step method in which, e.g., an untreated carbon fiber is first provided with a metal coating and after the coating is preferably wound up on a bobbin. In a later method step, the carbon fiber provided with a metal coating can be drawn through a finishing bath which contains, for example, an aqueous dispersion of the polymer binder and the conductive nanoparticles.

However, the metal coating and the application of the finish preferably take place in a continuous process directly in sequence, i.e., steps a) to c) are performed consecutively in a continuous process. The coating process for deposition of a metal on the filaments can comprise washing and drying steps which precede or follow the coating and/or deposition of the metal.

The coating process for deposition of a metal in the form of a metal coating on the filaments of the carbon fiber is preferably an electroplating process. Electroplating processes of this type for the deposition of metal coatings on carbon fibers are described for example in EP-A-0 149 763 A or in the article, Y. X. Gan, “Electrolytic Metallic Coatings for Carbon Fibers”, Materials and Manufacturing Processes, Vol. 9, No. 2, 263-280, 1994, Marcel Dekker Inc., to which reference is explicitly made with regard to the disclosure thereof.

The metals applied as a coating in step b) can be the previously listed metals or metal alloys. Copper is preferably applied to the filaments of the carbon fiber in step b). In this case, the copper is preferably applied from an aqueous electrolyte bath containing copper sulfate with the addition of tartrates as complexing agents. The carbon fiber, provided with a metal coating when leaving the electrolyte bath, is preferably washed to remove excess electrolyte and loosely adhering substances and is subsequently dried in a dryer.

Known measures can be used to apply the finish to the metal-coated carbon fiber according to step c) of the method according to the invention. For example, the finish can be applied by impregnation of the metal-coated carbon fiber with a melt or a solution of the polymer binder containing the conductive nanoparticles. The application of the finish of step c) is, preferably an impregnation step in which the carbon fiber filaments are impregnated with the aqueous dispersion containing the polymer binder and conductive nanoparticles. The conductive nanoparticles contained in the finish are preferably carbon nanotubes.

Subsequent to the impregnation, the carbon fiber now provided with the finish is dried. In this case, a drying temperature in the range from 100 to 160° C. has proven to be particularly suitable.

By means of the carbon fibers with a conductive finish according to the invention, composite materials or composite material components can be produced which have a high conductivity and in particular a high bulk conductivity with simultaneously low specific gravity. Therefore, the present invention also relates to a fiber-reinforced composite material of this type comprising carbon fibers with a conductive finish, consisting of carbon fiber filaments, wherein the carbon fiber filaments are coated with a metal, i.e., have a metal coating, and a polymer-based matrix, wherein the percent by volume of the carbon fibers in the composite material lies in the range from 30 to 70 vol. %, and wherein the fiber-reinforced composite material is characterized in that it further contains conductive nanoparticles which are dispersed at least partially in the matrix.

The polymer-based matrix can be a matrix of a thermoplastic or a duromer. Preferably, the polymer-based matrix is an epoxy resin matrix, which however can also contain conventional additives for composite materials, such as thermoplastic particles to increase the impact strength of the composite material.

In a preferred embodiment, the concentration of the metal in the composite material lies in the range from 2.5 to 30 wt. % relative to the weight of the carbon fibers contained in the composite material. In a further preferred embodiment, the concentration of the conductive nanoparticles in the composite material lies in the range from 0.04 to 0.65 wt. %. A composite material is particularly preferred in which the concentration of the metal in the composite material lies in the range from 2.5 to 30 wt. % relative to the weight of the carbon fibers contained in the composite material and the concentration of conductive nanoparticles in the composite material lies in the range from 0.04 to 0.65 wt. %. The conductive nanoparticles are preferably carbon nanotubes.

The invention is explained in more detail on the basis of the following figures, examples, and comparative examples. Within the context of the present invention, the following analysis and measuring methods are used for this purpose:

Concentration of the Metal Coating as Well as Concentration of the Conductive Nanoparticles on the Filaments of the Carbon Fiber:

The concentration of the metal coating as well as the concentration of the conductive nanoparticles on the filaments of the carbon fiber are determined using EN ISO 10548.

In the process, the finish is initially removed from the carbon fiber by means of Soxhlet extraction according to Method A of EN ISO 10548. The concentration of conductive nanoparticles is then determined using thermogravimetric analysis of the extract in a nitrogen atmosphere.

After removing the finish from the conductive carbon fiber, the metal coating on the carbon fiber filaments is removed by wet chemical oxidation using a sulfuric acid/hydrogen peroxide mixture according to Method B of EN ISO 10548, and the concentration of the metal coating is calculated by reweighing the carbon fiber residue after drying thereof.

Production of Laminates for Test Bodies for Determining Conductivity:

The production of the laminates took place following Method A described in EN 2565 (wet application method). To produce the carbon fiber composite, carbon fiber yarn was wound up at a constant thread tension on a winding plate having two parallel forms lying opposite on the sides of the winding plate, which forms have lateral bars for limiting the coiling width. During the winding up, the carbon fiber yarn was impregnated with pre-heated resin (resin system RTM6, Hexcel). The impregnation took place by means of roller impregnation, wherein the resin amount to be applied was set using a doctor blade. The winding on the plate took place with a fiber mass per unit area of approximately 300 g/m² per layer as a target variable. The number of layers then resulted from the intended thickness of the test body, wherein the target resin content was 40 vol. %.

During the subsequent treatment, the two laminate structures arranged on the opposing surfaces, with carbon fibers arranged unidirectionally in the 0° direction, were cured for two hours in the autoclave at 180° C. and a pressure of 10 bar. The use of bleeder cloths for absorbing excess resin as well as cutting open the laminate structures on the front faces of the winding plate after achieving the pot time to relieve inner tension are further measures for achieving the quality of the carbon-fiber-reinforced test plates required in EN 2565, wherein all steps are to be coordinated with each other such that the resin proportion of the finished laminate is preferably 40±4 vol. %.

Test bodies for the determination of the conductivity were cut from the laminates obtained. Further, samples were extracted from the laminates for producing microsections and scanning electron microscopic images as well as for determining the fiber volume proportion and the concentrations of the metal coating.

Determination of Conductivity:

The determination of conductivity took place via the determination of the electrical resistance following DIN EN ISO 3915.

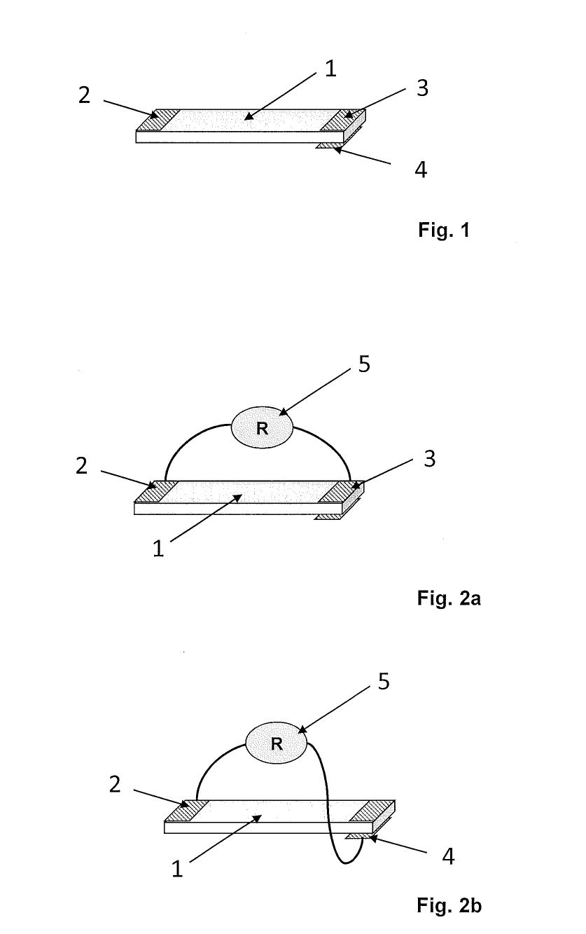

From the laminates produced, three test pieces were respectively provided in the dimensions 140×10 mm. Three contact areas 2, 3, 4, with respective contact surfaces of 200 mm², were marked on test pieces 1, as depicted in FIG. 1.

To improve the electrical contact, 5% of the initial thickness was subsequently removed from the test body at the contact surfaces 2, 3, 4 using a milling machine. An approximately 10 μm thick layer of contact silver was applied to the contact surfaces 2, 3, 4 treated in this way and the thickness of said layer was determined using a thickness gage.

The electrical resistance R was determined with a multimeter 5 (e.g. Keithley Model 2000) according to the measuring points in FIGS. 2a and 2b using the four pole method, as required in DIN EN ISO 3915.

The resistivity ρ, expressed in ohm-centimeters [Ωcm], was calculated according to the following equation:

$$ρ = \frac{R \cdot A}{L} [ \begin{matrix}Ω & cm\end{matrix} ] , \qquad ( I )$$

where:
ρ=resistivity [Ωcm];
R=resistance measured [Ω];
A=thickness×width of the test body [cm²];
L=11.5 cm (=distance of the measuring calipers, i.e. the path along the test body across which the resistance is to be measured).

The conductivity σ in [S/m] is calculated as the reciprocal of the resistivity:

$$σ = \frac{1}{ρ} [ S \text{/} m ] \qquad ( II )$$

The conductivity determined using measuring arrangement 1, depicted in FIG. 2a, in which the electrodes were thus located at the contact areas 2, 3 at the ends of the test body and on the same surface of the test body, is a measure of the conductivity in the fiber direction of the test body. In contrast, the conductivity determined using measuring arrangement 2, depicted in FIG. 2b, in which the electrodes were thus located at the contact surfaces 2, 4 at the ends of the test body and on different surfaces of the test body, is a measure of the conductivity transverse to the fiber direction, i.e. in the direction of the thickness of the test body, and thus a measure of the bulk conductivity.

Percent by Volume of Fiber and Concentration of the Metal Coating in the Composite Material:

The percent by volume of the pure carbon fibers in the composite material as well as the mass thereof in the test body is determined according to EN ISO 10548, Method B, using extraction by means of sulfuric acid/hydrogen peroxide.

In a further step, the mass of copper which was contained in the test body is determined using electrogravimetric determination from the extract thus obtained, which extract contains the copper in ion form. The concentration of the metal in the composite material, relative to the weight of the pure carbon fiber contained in the composite material, results from the mass of carbon fibers contained in the test body.

### EXAMPLE 1

An untreated and dry carbon fiber filament yarn was provided having a yarn linear density of 800 tex and 12000 filaments. The carbon fiber filament yarn was coated with copper according to the galvanic method described in the article by Y. X. Gan, “Electrolytic Metallic Coatings for Carbon Fibers”, Materials and Manufacturing Processes, Vol. 9, No. 2, 263-280, 1994, Marcel Dekker Inc. The method was carried out using a copper sulfate bath conditioned to 23° C. with the addition of potassium sodium tartrate, with a composition of the electrolyte bath of 80 g CuSO₄*5H₂O, 100 g KNaC₄H₄O₆*5H₂O, 30 g K₂CO₃ and 1 liter H₂O. The untreated carbon fiber filament yarn was fed over a first cathode roller arranged outside of the galvanic bath and subsequently over a first moveable spreader bar (brass rod) within the galvanic bath and thereby fed past a copper anode located in the bath. Subsequently, the carbon fiber filament yarn already partially provided with a metal coating was fed over a second cathode roller arranged outside of the galvanic bath and then fed again over moveable spreader bars in the galvanic bath past the copper anode within the galvanic bath. The fiber speed was 0.3 m/min. A voltage of 15 V was provided from a power supply connected to the cathodes and the copper anode.

After applying the metal coating, the carbon fiber filament yarn provided with copper was fed through a washing bath containing water to wash away excess electrolyte. Subsequently, the coated carbon fiber filament yarn passed through a dryer.

After drying, the coated carbon fiber filament yarn was fed through a bath having an aqueous dispersion to apply the finish, which dispersion contained as solid components a polyurethane resin composition as well as multi-walled carbon nanotubes. The solids proportion of the dispersion was 5 wt. %. The bath was conditioned to a temperature of 23° C.

The dispersion contained in the finishing bath was obtained by combining two initial dispersions. The first initial dispersion comprised a polyester-based polyurethane resin with a softening range of 180-185° C. (Vondic 1230 NE; Daininppon Ink & Chemicals) as a dispersion in water. The first initial dispersion was diluted regarding the solids content so that a solids concentration of 1 wt % resulted.

The second initial dispersion had a solids content of approximately 26 wt. % of a polyester-based urethane polymer which was modified with 5 wt. % carbon nanotubes. The second initial dispersion was diluted regarding the solids content thereof such that a solids concentration of 4 wt. % resulted.

First and second initial dispersions were mixed together so that the solids contents of the resulting dispersion, i.e., the polyester-based polyurethane resin (Vondic 1230 NE) on the one hand and the polyester-based urethane polymer and carbon nanotubes on the other, were present in a ratio of 20:80.

After passing through the bath containing the aqueous dispersion of the finish, the yarn now also provided with the finish was dried at a temperature of 150° C.

The carbon fiber yarn obtained, provided with finish and copper coating, had a copper content of 13.14 wt. % and a concentration of carbon nanotubes of 0.13 wt. %, each relative to the weight of the carbon fiber provided with the copper coating and finish. The finish proportion of the carbon fiber was 3.51 wt. %.

### EXAMPLE 2

This proceeded as in Example 1. Departing from Example 1, a voltage of 4.5 V was applied to the cathodes and the copper anode.

To apply the finish, a dispersion with an epoxy resin composition was used as the first initial dispersion, which dispersion comprised a first epoxy resin H1 and a second epoxy resin H2, wherein the weight ratio of the resins H1 and H2 was 1.2. The first epoxy resin H1 had an epoxy value of approximately 2000 mmol/kg and an average molecular weight M_{N} of 900 g/mol, and was solid at room temperature; the second epoxy resin H2 had an epoxy value of approximately 5400 mmol/kg and an average molecular weight M_{N} of <700 g/mol, and was liquid at room temperature. The first initial dispersion was diluted to yield a resin proportion of 2.2 wt. %.

The second initial dispersion had a solids content of approximately 6.2 wt. % of a polyhydroxyether, carbon nanotubes, and surfactants in the ratio 60:30:10. The second initial dispersion was also diluted to yield a solids content of 2.2 wt. %.

The first and second initial dispersions were mixed together so that the solids content of the resulting dispersion, i.e., H1 and H2 on the one hand and polyhydroxyether, carbon nanotubes, and surfactants on the other, were present in a ratio of 50:50.

The carbon fiber yarn obtained, provided with finish and copper coating, had a copper content of 11.45 wt. % and a concentration of carbon nanotubes of 0.27 wt. %, each relative to the weight of the carbon fiber provided with the copper coating and finish. The finish proportion of the carbon fiber was 2.1 wt. %.

### EXAMPLE 3

This proceeded as in Example 2. Departing from Example 2, the first initial dispersion was diluted to a concentration of 1.5 wt. %

The first and second initial dispersions were mixed together so that the solids content of the resulting dispersion, i.e., H1 and H2 on the one hand and polyhydroxyether, carbon nanotubes, and surfactants on the other, were present in a ratio of 50:50.

The carbon fiber yarn obtained, provided with finish and copper coating, had a copper content of 10.7 wt. % and a concentration of carbon nanotubes of 0.12 wt. %, each relative to the weight of the carbon fiber provided with the copper coating and finish. The finish proportion of the carbon fiber was 0.94 wt. %.

### COMPARISON EXAMPLE 1

A copper coating, as described in Example 1, as well as subsequently a finish, was applied to a carbon fiber yarn according to Example 1. Departing from Example 1, however, the finish bath contained only the first initial dispersion with the epoxy resin composition as indicated in Example 2. The solids concentration of the dispersion was 4.3 wt. %.

The carbon fiber yarn obtained, provided with finish and copper coating, had a copper content of 13.22 wt. % relative to the weight of the carbon fiber provided with the copper coating and finish. The finish proportion of the carbon fiber was 2.81 wt. %.

### EXAMPLES 4 TO 6 AND COMPARISON EXAMPLES 2 TO 5

Laminates and test bodies were produced from the carbon fiber yarns produced according to Examples 1 to 3 and Comparison example 1 following the previously described method, and the material characteristics were determined for these laminates and test bodies, in particular the conductivity (Examples 4 to 6, Comparison example 2). In addition, corresponding laminates having the following configuration were produced and examined:

### COMPARISON EXAMPLE 3

A standard carbon fiber was used as a reinforcing fiber with a finish based on polyurethane resin without nanoparticles (Tenax HTS40 F13 12K; Toho Tenax Europe GmbH).

### COMPARISON EXAMPLE 4

A standard carbon fiber was used as a reinforcing fiber with a finish based on polyurethane resin (Tenax HTS40 F13 12K; Toho Tenax Europe GmbH). During the laminate production, a copper mesh of the type Astrostrike CU 015 (manufactured by Astrostrike) with a mass per unit area of 73 g/m² was laminated to one of the surfaces of the laminate. The contact surfaces for determining the conductivity in the fiber direction of the test body (measuring arrangement 1; FIG. 2a) were located on this surface.

### COMPARISON EXAMPLE 5

A commercially available carbon fiber with a nickel coating and a finish based on polyurethane resin (Tenax HTS40 A23 12K; Toho Tenax Europe GmbH) was used as the reinforcing fiber. The finish did not contain any nanoparticles. The nickel-coated carbon fiber had a nickel concentration of approximately 30 wt. % relative to the weight of the carbon fiber provided with the nickel coating and finish.

The characteristics of the laminates obtained are listed in Tables 1 and 2.

TABLE 1

| | | | | | Concentration of | CNT |
|---|---|---|---|---|---|---|
| | Number of | | Laminate | Laminate | metal coating | concentration |
| | layers in | FVA | density | thickness | (rel. to untreated | in the |
| | the laminate | [%] 1) | [g/cm³] | [mm] | carbon fiber) | laminate 2) |
| Example 4 | 8 | 41.89 | 1.61 | 2.1927 | 15.66 | 0.07 |
| Example 5 | 8 | 52.36 | 1.58 | 2.1865 | 13.2 | 0.20 |
| Example 6 | 8 | 54.54 | 1.62 | 3.1122 | 12.1 | 0.09 |
| Comparison | 8 | 47.23 | 1.54 | 2.3292 | 15.66 | ./. |
| example 2 | | | | | | |
| Comparison | 8 | 65.15 | 1.56 | 2.0238 | ./. | ./. |
| example 3 | | | | | | |
| Comparison | 8 | 64.12 | 1.60 | 2.0161 | n.a. 3) | ./. |
| example 4 | | | | | | |
| Comparison | 14 | 45.98 | 2.01 | 2.4581 | 45 | ./. |
| example 5 | | | | | | |

1) FVA = Fiber volume as percent of the laminate [%]
2) CNT = Carbon nanotubes
3) n.a.; Cu mesh used

TABLE 2

| | | | | | | | Spec. conductivity [%] | |
|---|---|---|---|---|---|---|---|---|
| | | | | | Spec. conductivity [%] | | (relative to standard | |
| | Resistivity | | Conductivity | | (relative to standard | | carbon fiber + 60 vol. % of | |
| | [Ω*cm] | | [S/m] | | carbon fiber) | | fibers by volume) | |
| | Meas. | Meas. | Meas. | Meas. | Meas. | Meas. | Meas. | Meas. |
| | arrangement 1 | arrangement 2 | arrangement 1 | arrangement 2 | arrangement 1 | arrangement 2 | arrangement 1 | arrangement 2 |
| Example 4 | 0.0020 | 0.0023 | 51243 | 42981 | 205 | 224 | 320 | 349 |
| Example 5 | 0.0021 | 0.0022 | 46792 | 44650 | 188 | 233 | 233 | 290 |
| Example 6 | 0.0027 | 0.0034 | 37405 | 29317 | 484 | 566 | 550 | 642 |
| Comparison | 0.0027 | 0.0030 | 36984 | 32861 | 148 | 171 | 205 | 237 |
| example 2 | | | | | | | | |
| Comparison | 0.0040 | 0.0052 | 24945 | 19169 | 100 | 100 | 100 | 100 |
| example 3 | | | | | | | | |
| Comparison | 0.0004 | 0.0026 | 238158 | 37966 | 955 | 198 | 970 | 201 |
| example 4 | | | | | | | | |
| Comparison | 0.0001 | 0.0002 | 748454 | 610490 | 3000 | 3185 | 4251 | 4513 |
| example 5 | | | | | | | | |

1. A carbon fiber with a conductive finish, comprising carbon fiber filaments which have a metal coating, wherein
the carbon fiber filaments have a finish on the metal coating that comprises at least one polymer binder and containing conductive nanoparticles, and
the concentration of the metal coating is 8 to 25 wt. % and the concentration of conductive nanoparticles is 0.1 to 1 wt. %, each relative to the weight of the carbon fiber provided with the metal coating and finish.

2. A carbon fiber according to claim 1, wherein the concentration of the conductive nanoparticles is 0.1 to 0.5 wt. % relative to the weight of the carbon fiber provided with the metal coating and finish.

3. A carbon fiber according to claim 1, wherein the conductive nanoparticles are carbon nanotubes.

4. A carbon fiber according to claim 1, wherein the concentration of the metal coating is 10 to 25 wt. %.

5. A carbon fiber according to claim 1, wherein the metal forming the metal coating is copper.

6. A method for producing carbon fibers for composite materials having improved conductivity, comprising:
a) provision of a carbon fiber comprising carbon fiber filaments,
b) performing a coating process to deposit a metal in the form of a metal coating on the filaments, and
c) application of a finish to the filaments provided with the metal coating, wherein the finish contains conductive nanoparticles.

7. A method according to claim 6, wherein the steps a) to c) are performed in sequence in a continuous process.

8. A method according to claim 6, wherein step b) is an electroplating process.

9. A method according to claim 6, wherein the metal deposited in step b) is copper.

10. A method according to claim 6, wherein step c) for applying the finish is an impregnation step, in which the carbon fiber filaments are impregnated with an aqueous dispersion containing the conductive nanoparticles.

11. A method according to claim 10, wherein the dispersion additionally contains at least one epoxy resin and/or at least one polyurethane resin.

12. A fiber-reinforced composite material comprising carbon fibers comprised of carbon fiber filaments, wherein the carbon fiber filaments are coated with a metal, and a polymer-based matrix, wherein the percent by volume of the carbon fibers in the composite material is 30 to 70 vol. %, wherein the composite material additionally contains conductive nanoparticles which are dispersed at least partially in the matrix.

13. A fiber-reinforced composite material according to claim 12, wherein the concentration of the metal in the composite material lies in the range from 2.5 to 30 wt. % relative to the weight of the carbon fibers contained in the composite material.

14. A fiber-reinforced composite material according to claim 12, wherein the concentration of the conductive nanoparticles in the composite material lies in the range from 0.04 to 0.65 wt. %.

15. A fiber-reinforced composite material according to claim 12, wherein the conductive nanoparticles are carbon nanotubes.
